(19) United States
(12) Patent Application Publication
(10) Pub. No.: US 2012/0137875 A1
(43) Pub. Date: Jun. 7, 2012

(54) CYLINDER ASSEMBLY FOR PNEUMATIC MOTOR AND PNEUMATIC MOTOR COMPRISING THE SAME

(76) Inventors: Tien LIN, Taichung (TW); Yen-Che Chiang, Taichung (TW)

(21) Appl. No.: 13/369,868

(22) Filed: Feb. 9, 2012

Related U.S. Application Data
(63) Continuation-in-part of application No. 12/898,168, filed on Oct. 5, 2010.

(51) Int. Cl. F16J 10/00

(52) U.S. Cl. 92/169.1

(57) ABSTRACT

A pneumatic motor of the present invention includes a cylinder assembly and a rotor. The cylinder assembly defines a chamber for receiving the rotor, two air passages, and one or several apertures. The air passages are prepared for pressurized air to be input for driving the rotor to rotate in two different rotation conditions. The cylinder assembly has an adjustment mechanism for blocking all of the apertures. Thus, once air is input via one of the air passages, the air has to be released from the other air passage. Therefore, a specific power stage is provided with the pneumatic motor.

The present invention is a CIP of application Ser. No. 12/898,168, filed Oct. 5, 2010, the entire contents of which are hereby incorporated by reference.

### BACKGROUND OF THE INVENTION

1. Field of the Invention

2. Description of the Prior Art

Some pneumatic motors, as shown in TW 1259865 and TW 1325808, have several outlets. Pressurized air can be released to surroundings via one of the outlets. By choosing one of the outlets, the power stroke may be lengthened. As such, the power of the pneumatic may be enlarged.

In addition, patent document U.S. Pat. No. 7,174,971 provides another pneumatic motor which has air input selection mechanism for adjusting rotation direction of the motor. The pneumatic motor has two air passages for pressurized air to be input and output. In general, pressurized air flows into the motor via one of the air passages. After driving the rotor, most air flows out of the motor via outlets on the cylinder. The remaining air is further released from the other air passage.

However, in some specialized condition, such increased power is too strong to be used. Overly increased power can damage threaded components easily. Therefore, pneumatic motor, as disclosed in TW 1345514, which has slightly decreased power is then created.

Accordingly, by the mechanisms disclosed in the documents mention above, power of pneumatic motor is increased and decreased. Effects of the mechanisms fight against each other. Technical resources and producing resources are squandered.

The present invention is, therefore, arisen to obviate or at least mitigate the above mentioned disadvantages.

### SUMMARY OF THE INVENTION

The main object of the present invention is to provide a pneumatic motor which has plenty of power stages, including weakened power stage. Thus, user can choose the suitable stage for working.

To achieve the above and other objects, a cylinder assembly for pneumatic motor of the present invention is revealed hereinafter. The cylinder assembly defines a cylindrical chamber for receiving a rotor therein. An axial direction is defined by the chamber. The cylinder assembly has two air passages communicating with the chamber respectively. The air passages are adapted for air to flow therethrough. Air drives the rotor received in the chamber to rotate when air flows into the chamber via one of the air passages. Air drives the rotor received in the chamber to rotate along an opposite direction when air flows into the chamber via the other air passage. When air drives the rotor through one air passage, the other air passage is used for air exhaust.

The cylinder assembly further defines an aperture which communicates with the chamber. The one or more apertures and the air passages are arranged about the axial direction and around the chamber.

The cylinder assembly comprises an adjustment mechanism for selectively blocking one or several of the apertures. Air can flow in and out of the chamber via only the air passages when all apertures are blocked.

In addition, a pneumatic motor of the present invention includes the cylinder assembly and a rotor. The rotor is rotatably and eccentrically disposed in the chamber of the cylinder assembly. The air passages communicate with the chamber at a peripheral inner surface of the chamber and locating close to the rotor, so that air is able to drive the rotor to rotate when the air flows into the chamber via one of the air passages.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a profile showing a first embodiment of the present invention;

FIG. 3 is a break down drawing showing a first embodiment of the present invention;

FIG. 3A is a stereogram showing a leading member of a first embodiment of the present invention;

FIG. 3B is a stereogram showing an adjusting member of a first embodiment of the present invention;

FIG. 4 is a profile showing a using condition of a first embodiment of the present invention, wherein one of two apertures is blocked;

FIG. 5 is a profile showing a using condition of a first embodiment of the present invention, wherein both of two apertures is blocked;

FIG. 6 is a stereogram showing a second embodiment of the present invention;

FIG. 7 is a break down drawing showing a second embodiment of the present invention;

FIG. 8 is a profile showing a using condition of a second embodiment of the present invention, wherein one of two apertures is blocked;

FIG. 9 is a profile showing a using condition of a second embodiment of the present invention, wherein both of two apertures is blocked;

FIG. 10 is a stereogram showing a third embodiment of the present invention;

FIG. 11 is a break down drawing showing a third embodiment of the present invention;

FIG. 11A is a stereogram showing an air guider of a third embodiment of the present invention.

### DETAILED DESCRIPTION OF THE PREFERRED EMBODIMENTS

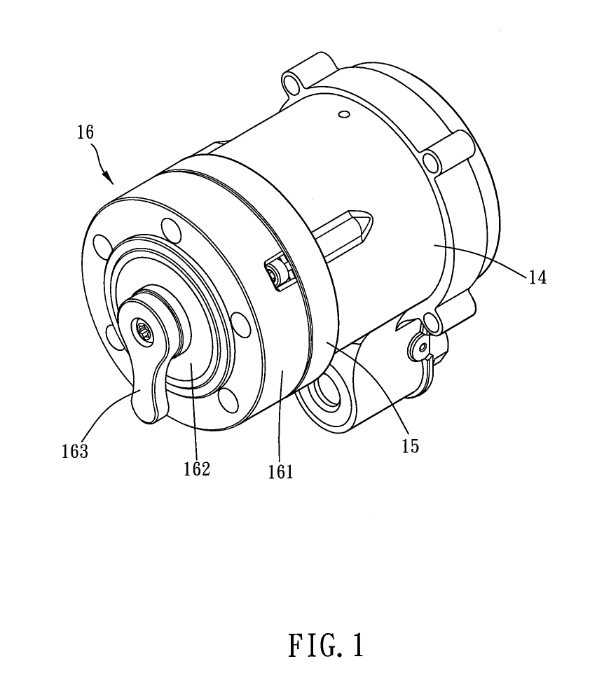

Please refer to FIG. 1 to FIG. 4 for a first embodiment of the present invention. The pneumatic motor of the present embodiment is prepared for power tools, such as grinder or wrench. The pneumatic motor is powered by pressurized air. The pneumatic motor includes a cylinder assembly for pneumatic motor and a rotor 2.

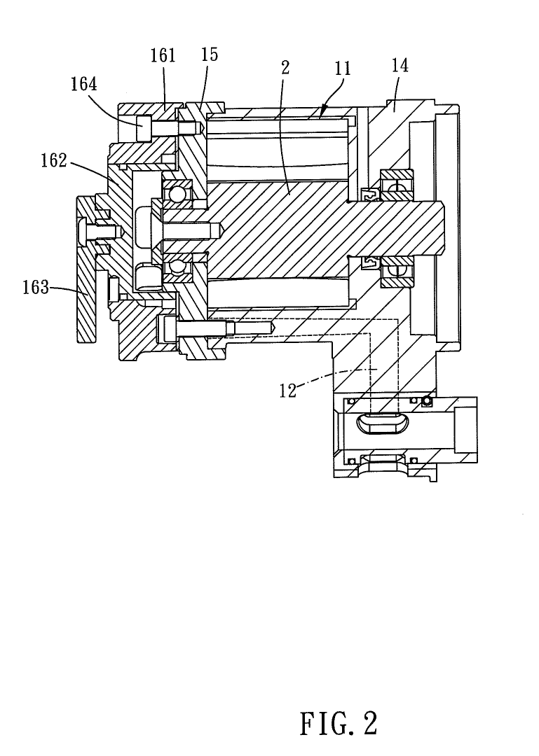

The cylinder assembly defines a cylindrical chamber 11 for receiving a rotor therein, two air passages 12, and one or several apertures 13. The chamber 11 defines an axial direction. The air passages 12 and the apertures 13 communicate with the chamber 11 respectively, so that air can flow into or out of the chamber 11 via one of the air passages 12 and the apertures 13. The air passages 12 and the apertures 13 are arranged about the axial direction and around the chamber 11. More particularly, the cylinder assembly includes a main body 14, a rear cover 15, and an adjustment mechanism 16. The rear cover 15 is firmly affixed to the main body 14 by several threaded members so as to define the chamber 11 therebetween. The air passages 12 are formed in the main body 14, in particularly, the lower extension portion of the main body 14, as shown in FIG. 2, communicating with the chamber 11 at a peripheral inner surface of the chamber 11. The apertures 13 are formed on the rear cover 15.

The adjustment mechanism 16 is used for selectively blocking the apertures 13. Thus, when the apertures 13 are blocked, air can flow passing through only the air passages 12, and can not flow passing through the apertures 13. Said blocking is defined that the air is unable to pass through the apertures 13. In the present embodiment, the apertures are coved for blocking. In other possible embodiments, the apertures may be filled for blocking.

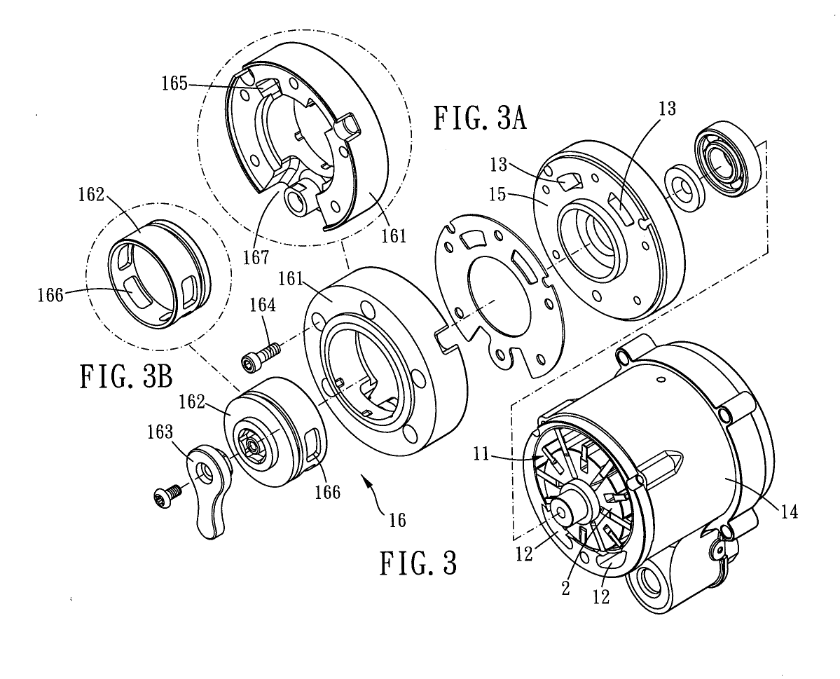

More specifically, the adjustment mechanism 16 includes a leading member 161, an adjusting member 162, and a switch 163. The leading member 161 is firmly affixed to the rear cover 15 by several threaded members 164. As shown in FIG. 3A, the leading member 161 is formed with leading grooves 165 whose quantity corresponds to quantity of the apertures 13. The leading grooves 165 communicate with the apertures 13 respectively. The leading member 161 is made annularly. The leading grooves 165 communicate with the apertures 13 along the axial direction, opening inwardly. The adjusting member 162 is rotatably disposed in the leading member 161, and is surrounded by the leading member 161. The adjusting member 162 is operated for selectively covering and blocking the leading grooves 165. For adjustment purpose, the adjusting member 162 is formed with several orifices 166 whose quantity corresponds to quantity of the leading grooves 165, as shown in FIG. 3B. The orifices 166 and the leading grooves 165 are arranged radially since the adjusting member 162 is disposed in the leading member 161. The adjusting member 162 is able to rotate for achieving or breaking communication between the orifices 166 and the leading grooves 165. The leading member 161 is further formed with an outlet 167. When one of the orifices 166 communicates with one of the leading grooves 165, air can flow passing through the leading groove 165, two orifices 166, and the outlet 167, released to the surroundings. In other possible embodiments of the present invention, the outlet 167 may be formed on the adjusting member 162. The switch 163 is disposed on the adjusting member 162, achieving a rotational operation relationship with the adjusting member 162. The switch 163 is provided for user to rotate. In addition, aiming direction defined by the switch 163 can be identified position of the adjusting member and connection condition of the orifices 166, pointing out the power stage of the pneumatic motor. In other possible embodiments of the present invention, the switch 163 can integrally protrude from the adjusting member 162. In other words, the switch may be formed with the adjusting member in single piece.

The rotor 2 is rotatably and eccentrically disposed in the chamber 11. The rotor 2 is shifted from center of the chamber and is close to the air passages 12 located at lower extension portion of the main body 14. Thus, pressurized air drives the rotor received in the chamber to rotate when pressurized air flows into the chamber via one of the air passages 12. Pressurized air drives the rotor to rotate along an opposite direction when pressurized air flows into the chamber via the other air passage. For directing pressurized air into the correct or desired air passage 12, the main body 14 may be further assembled with a controlling valve in the lower extension portion of the main body 14.

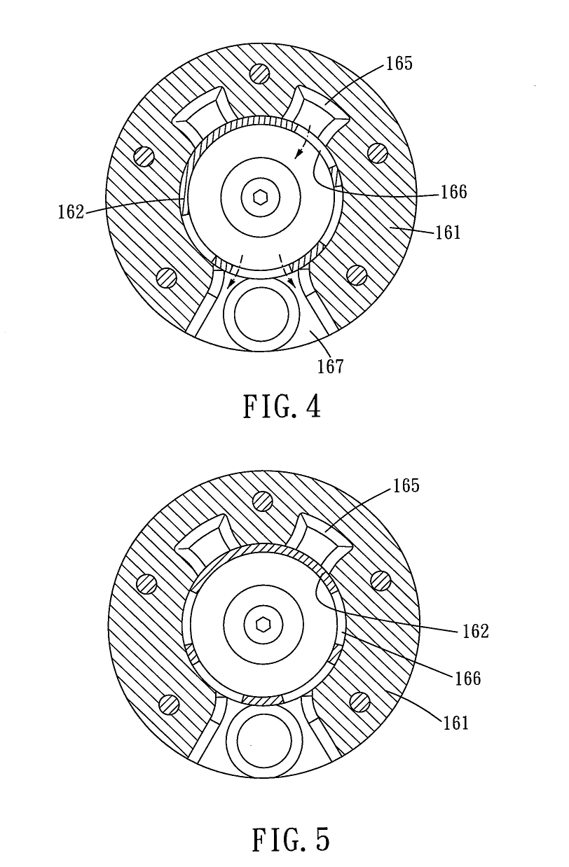

For operation, pressurized air can be input into the pneumatic motor. Firstly, the adjusting member 162 is rotated to a predetermined position for a suitable power stage, as shown in FIG. 4. One of the leading grooves 165, both with the aperture 13 connected thereto, is opened and communicated with the orifice 166. By conduction of controlling valve settled in the lower extension portion of the main body 14, pressurized air flows into the chamber 11 via one of the air passages 12, drives the rotor 2 to rotate, and is released to the surroundings via the aperture 13, the leading groove 165, the orifice 166, and the outlet 167. In addition, air remaining in the chamber after moves passing by the apertures 13 can be released via the other air passage 12, so that resistance caused by air obstruction is reduced.

For adjusting power stage, the adjusting member 162 can be rotated. Thus, pressurized air can be released to the surroundings via the leading groove and the aperture chosen. The power stroke of pressurized air is then changed for a suitable power stage.

Furthermore, the adjusting member is able to block all of the leading grooves 165. In this condition, pressurized air flowed into the chamber from one of the air passages 12 can be released via only the other one of the air passages 12. Pressurized air would move along the inner surface of the chamber almost a circle. Thus, a new power stage of weakened torque is provided different from the power stages provided with the leading grooves. That is to say, there are total three power stages, two provided from the apertures 13 and one provided from the air passages 12, in present pneumatic motor which has only two apertures 13. Quantity of the power stages provided is more than that of the apertures 13.

Accordingly, the pneumatic motor has power stages for user to choose from. One of the power stages which achieved by blocking all of the apertures 13 has significantly lowered power or torque. The power stage mentioned is not disclosed by previous pneumatic motors in the art, such as the pneumatic motor disclosed in U.S. Pat. No. 7,174,971. By the disclosure of U.S. Pat. No. 7,174,971, it does mention that pressurized air can flow into the chamber via one of the air passages, and flow out of the chamber via the other air passage. However, as disclosed in column 3 lines 54-57 of the specification of U.S. Pat. No. 7,174,971, “After the pressurized air is passed to drive the pneumatic motor module, a remaining air affecting the working efficiency of the pneumatic motor module will be produced.”, it should be noticed that the air flow out of the chamber from the air passage is “remaining air”. It is considered that the air is released from another outlet before arriving the air passage. Objectively speaking, Chen, the inventor of U.S. Pat. No. 7,174,971, tries to control rotation direction of the pneumatic motor by choosing from where the pressurized air is input. Chen's statement does nothing about power adjustment. In comparison with U.S. Pat. No. 7,174,971, the pneumatic motor of the present application may be assembled with the controlling valve in the lower extension portion of the main body 14 for rotation direction control and selection. The present application concerns on controlling power of the pneumatic motor by choosing from where the pressurized air is released. The adjustment mechanism of the pneumatic motor of the present application controls power, rather than rotation direction of the pneumatic motor. In the end, quantity of power stages is superiorly provided.

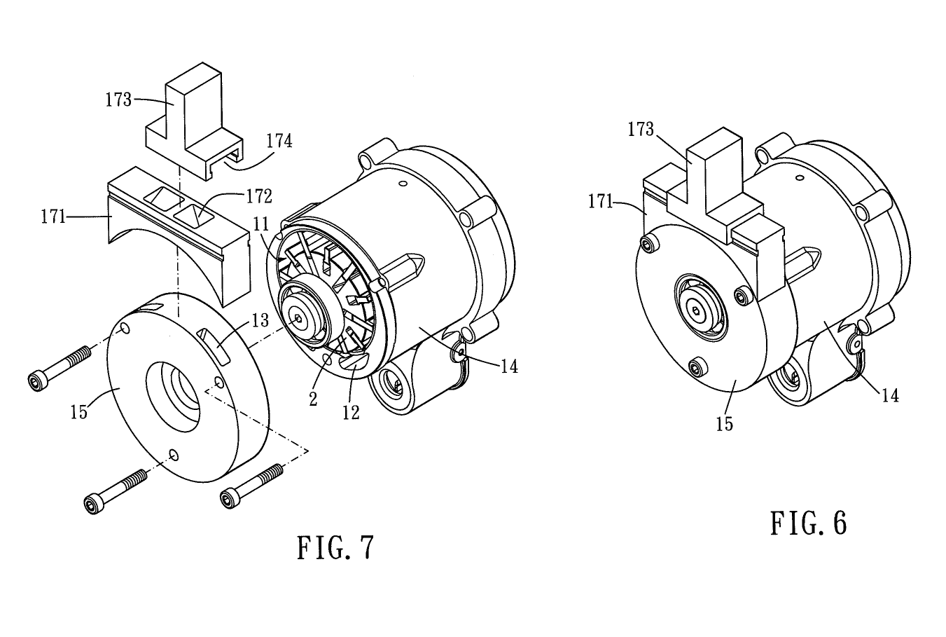

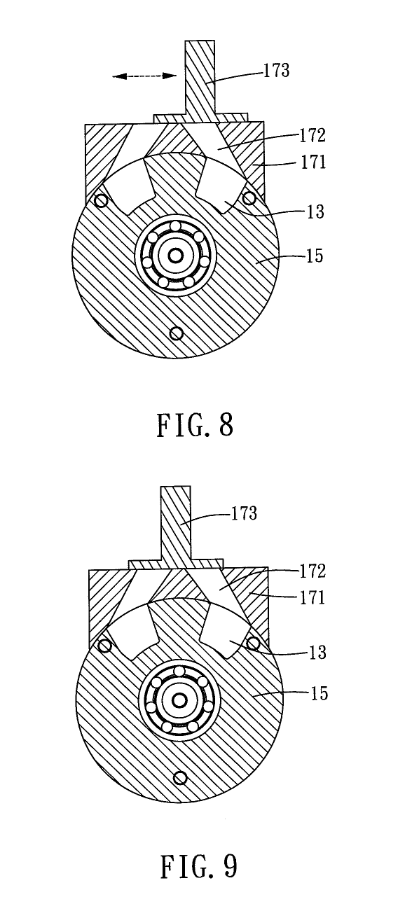

Please refer to FIG. 6 and FIG. 7 for a second embodiment of the present invention. The apertures 13 formed on the rear cover 15 may be directed and extend upwardly. The leading member 171 is then affixed upon the rear cover 15. The leading member 171 is formed with leading grooves 172 which communicate with the apertures 13 and extend upwardly. The adjusting member 173 is formed with a trapeziform sliding groove 174. The adjusting member 173 is slidably disposed on the leading member 171, as shown in FIG. 8 and FIG. 9. The adjusting member 173 is provided for sliding and covering and blocking one or all of the leading grooves 172. Thus, similar using condition of power stage adjustment as mentioned in the first embodiment is achieved. Additionally, it is also possible to form the rear cover 15 and the leading member 171 in single piece.

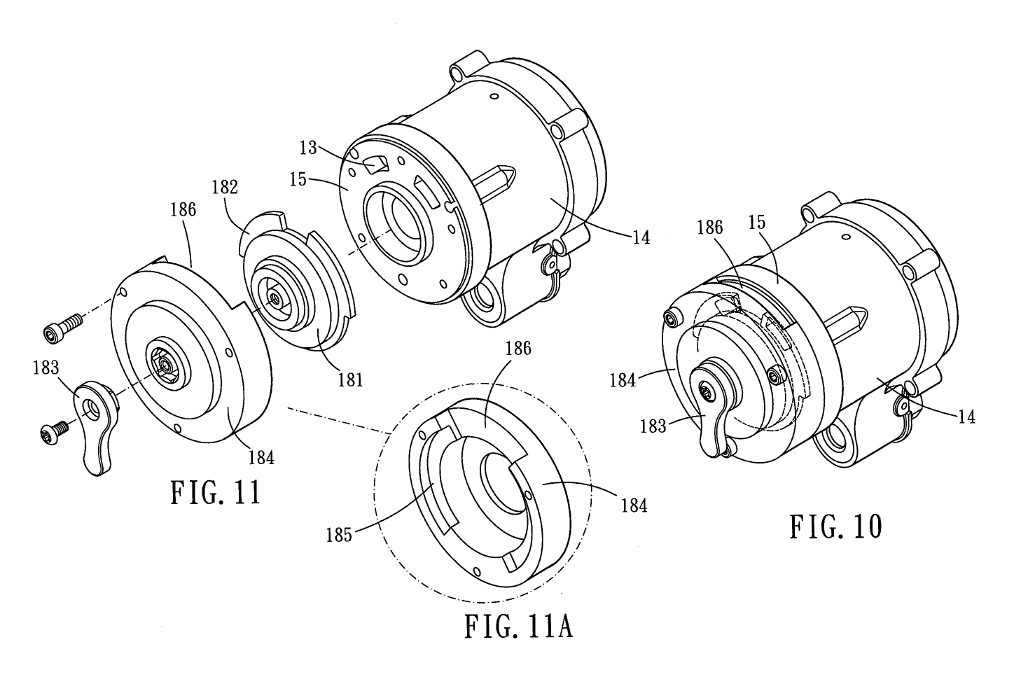

Please refer to FIG. 10 and FIG. 11 for a third embodiment of the present invention. In comparison with the first embodiment, the leading member of the adjustment mechanism is dismissed. Alternatively, the adjusting member 181 is rotatably disposed on the rear cover 15 directly. The adjusting member 181 is formed with two protrusions 182 protruding radially therefrom. The protrusions 182 are controlled by rotation of the adjusting member 181 so as to selectively cover and block the apertures 13. Additionally, a switch 183 is disposed on the adjusting member 181 for driving the adjusting member 183 to rotate. Moreover, an air guider 184 is firmly affixed to the rear cover 15, covering the adjusting member 181, as shown in FIG. 11A. The air guider 184 has recessed portion 185 corresponding to the adjusting member 181, so that motion of the adjusting member 181 is free from obstruction of the air guider 184. The air guider 184 has an opening 186 facing upwardly. Air released from the apertures 13 would be obstructed by the air guider 184, and be released upwardly from the opening 186.

To conclude, power stage of the pneumatic motor is adjustable. Not only higher but lower power can be provided by the pneumatic motor.

What is claimed is:

1. A cylinder assembly for pneumatic motor, defining a cylindrical chamber for receiving a rotor therein, an axial direction being defined by the chamber, the cylinder assembly having two air passages communicating with the chamber respectively, the air passages being adapted for air to flow therethrough, air driving the rotor received in the chamber to rotate when air flows into the chamber via one of the air passages, air driving the rotor received in the chamber to rotate along an opposite direction when air flows into the chamber via the other air passage;
wherein the cylinder assembly further defines an aperture which communicates with the chamber, the aperture and the air passages are arranged about the axial direction and around the chamber;
wherein the cylinder assembly comprises an adjustment mechanism for selectively blocking the aperture, air can flow in and out of the chamber via only the air passages when the aperture is blocked.

2. The cylinder assembly of claim 1, wherein the adjustment mechanism comprises a leading member and an adjusting member, the leading member is formed with at least one leading groove, the leading groove communicates with the aperture, and the adjusting member is operated for selectively covering the leading groove.

3. The cylinder assembly of claim 2, wherein the leading groove communicates with the aperture along the axial direction, and the adjusting member covers and blocks the leading groove along the axial direction.

4. The cylinder assembly of claim 3, wherein the leading member is formed annularly, the adjusting member is rotatably disposed in the leading member, so that the leading member surrounds the adjusting member, the adjusting member is formed with at least one orifice, and the adjusting member is adapted for rotating to communicate the orifice and the leading groove together.

5. The cylinder assembly of claim 2, wherein the adjusting member is slidably disposed on the leading member, and the adjusting member is adapted for sliding to cover and block the leading groove.

6. The cylinder assembly of claim 1, wherein the cylinder assembly defines plural apertures, the apertures and the air passages are arranged about the axial direction and around the chamber, the adjustment mechanism is adapted for selectively blocking all of the apertures.

7. The cylinder assembly of claim 6, wherein the adjustment mechanism comprises a leading member and an adjusting member, the leading member is formed with plural leading grooves whose quantity corresponds to quantity of the apertures, each of the leading grooves communicates with one of the apertures, and the adjusting member is operated for selectively covering the leading grooves.

8. The cylinder assembly of claim 7, wherein the leading grooves communicate with the apertures along the axial direction, and the adjusting member covers and blocks the leading grooves along the axial direction.

9. The cylinder assembly of claim 8, wherein the leading member is formed annularly, the adjusting member is rotatably disposed in the leading member, so that the leading member surrounds the adjusting member, the adjusting member is formed with at least one orifice, and the adjusting member is adapted for rotating to communicate the orifice and one of the leading grooves together.

10. The cylinder assembly of claim 7, wherein the adjusting member is slidably disposed on the leading member, and the adjusting member is adapted for sliding to cover and block the leading grooves.

11. The cylinder assembly of claim 1, wherein the adjustment mechanism comprises a rotatable adjusting member, the adjusting member selectively blocks the aperture when adjusting member is rotated.

12. A pneumatic motor, comprising the cylinder assembly of claim 1, further comprising a rotor, the rotor being rotatably and eccentrically disposed in the chamber of the cylinder assembly, the air passages communicating with the chamber at a peripheral inner surface of the chamber and locating close to the rotor, so that air is able to drive the rotor to rotate when the air flows into the chamber via one of the air passages.

13. The cylinder assembly of claim 12, wherein the adjustment mechanism comprises a leading member and an adjusting member, the leading member is formed with at least one leading groove, the leading groove communicates with the aperture, and the adjusting member is operated for selectively covering the leading groove.

14. The cylinder assembly of claim 13, wherein the leading groove communicates with the aperture along the axial direction, and the adjusting member covers and blocks the leading groove along the axial direction.

15. The cylinder assembly of claim 14, wherein the leading member is formed annularly, the adjusting member is rotatably disposed in the leading member, so that the leading member surrounds the adjusting member, the adjusting member is formed with at least one orifice, and the adjusting member is adapted for rotating to communicate the orifice and the leading groove together.

16. The cylinder assembly of claim 13, wherein the adjusting member is slidably disposed on the leading member, and the adjusting member is adapted for sliding to cover and block the leading groove.

17. The cylinder assembly of claim 12, wherein the cylinder assembly defines plural apertures, the apertures and the air passages are arranged about the axial direction and around the chamber, the adjustment mechanism is adapted for selectively blocking all of the apertures.

18. The cylinder assembly of claim 17, wherein the adjustment mechanism comprises a leading member and an adjusting member, the leading member is formed with plural leading grooves whose quantity corresponds to quantity of the apertures, each of the leading grooves communicates with one of the apertures, and the adjusting member is operated for selectively covering the leading grooves.

19. The cylinder assembly of claim 18, wherein the leading grooves communicate with the apertures along the axial direction, and the adjusting member covers and blocks the leading grooves along the axial direction.

20. The cylinder assembly of claim 19, wherein the leading member is formed annularly, the adjusting member is rotatably disposed in the leading member, so that the leading member surrounds the adjusting member, the adjusting member is formed with at least one orifice, and the adjusting member is adapted for rotating to communicate the orifice and one of the leading grooves together.
